(19) United States
(12) Patent Application Publication
(10) Pub. No.: US 2023/0349632 A1
(43) Pub. Date: Nov. 2, 2023

(54) Greenhouse Gas Capture and Sequestration System and Method with Collection Service

(71) Applicant: Patterson-UTI Drilling Company LLC, Houston, TX (US)

(72) Inventors: William Andrew HENDRICKS, JR., Houston, TX (US); Abelardo A. GALLO, Houston, TX (US); Roger Bartlett WILLIS, Meadville, PA (US)

(73) Assignee: Patterson-UTI Drilling Company LLC, Houston, TX (US)

(21) Appl. No.: 18/316,038

(22) Filed: May 11, 2023

Related U.S. Application Data
(63) Continuation-in-part of application No. 18/158,118, filed on Jan. 23, 2023.
(60) Provisional application No. 63/335,798, filed on Apr. 28, 2022.

(51) Int. Cl. F25J 1/00; E21B 41/00; F17C 5/02

(52) U.S. Cl. CPC F25J 1/0027; E21B 41/0064; F17C 5/02; B01D 53/1475; F17C 2221/013; F17C 2223/0123; F17C 2225/013; F17C 2250/04; F17C 2270/0171

(57) ABSTRACT

The disclosure provides a system to capture greenhouse gas, such as carbon dioxide, from exhausts of greenhouse gas emission sources on industrial sites, such as industrial grade power generators, and liquefy it for temporary onsite storage for collection and transportation to specifics sites for permanent carbon dioxide sequestration or utilization. The system can integrate the greenhouse gas emission source, with exhaust gas collection equipment, greenhouse gas capture equipment, greenhouse gas liquification equipment, and greenhouse gas fluid storage equipment for the onsite collection of the captured greenhouse gas from the greenhouse gas emission sources. The system can further include an on demand transport collection system having one or more transporters that can remove the liquified greenhouse products from the onsite storage equipment and transport the greenhouse products to a location for environmentally acceptable sequestration or utilization, thus reducing the amount of greenhouse gas released to the atmosphere.

### CROSS REFERENCE TO RELATED APPLICATIONS

This application is a continuation-in-part of US Application Serial No. 18/158,118, entitled “Integrated Wellsite System and Method for Greenhouse Gas Capture and Sequestration”, filed Jan. 23, 2023, which claims the benefit of U.S. Provisional Application Serial No. 63/335,798, entitled “Integrated Wellsite System and Method for Greenhouse Gas Capture and Sequestration”, filed Apr. 28, 2022, both of which are incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to efficient capture and sequestration of gaseous products with a collection system. More specifically, the disclosure relates to capture of potentially harmful greenhouse gases with a collection system toward sequestration of greenhouse products from the capture.

### Description of the Related Art

A growing concern in environmental protection is the increase of greenhouse gases. Greenhouse gases absorb and radiate heat gradually over time and help moderate global temperatures. However, an overabundance of greenhouse gases is believed to cause climate change and harm to the environment. Greenhouse gases include carbon dioxide, methane, nitrous oxide, and others. Carbon dioxide absorbs less heat than methane and nitrous oxide, but is far more abundant and stays in the atmosphere much longer. Some studies show that increases in atmospheric carbon dioxide contribute to about two-thirds of an apparent total energy imbalance that is believed to be causing Earth’s temperature to rise.

Significant efforts are being made to reduce production of greenhouse gases from industrial grade power generation equipment, particularly carbon dioxide due to its volume generated from internal combustion engines using fossil fuels, such as diesel, natural gas or a blend of both, that exhaust the carbon dioxide. However, current technology and industrial infrastructure heavily relies on such power generation equipment for a functional society. A typical composition of exhaust gas from a diesel engine is: carbon dioxide of about 12%; methane, nitrous oxide, and others of about 1%; nitrogen of about 67%; oxygen of about 9%; and water of about 11%. Greenhouse gases include carbon dioxide, methane, nitrous oxide, and others. Until alternative forms of power generation equipment become commercially available, the fossil fuel will be needed and, without a solution, it will continue to produce carbon dioxide that is released into the atmosphere after its combustion.

Therefore, there is a need for a system and method for capture and collection of greenhouse gases, such as carbon dioxide, from multiple industrial sites where the power generation equipment are located and ensure its subsequent sequestration or utilization to reduce the amount of greenhouse gases being released to the atmosphere.

### BRIEF SUMMARY OF THE INVENTION

The disclosure provides a system to capture greenhouse gas, such as carbon dioxide, from exhausts of any greenhouse gas emission source on industrial sites, such as having power generators, and liquefy it for temporary onsite storage. The system can integrate the greenhouse gas emission source, such as industrial grade power generators, with exhaust gas collection equipment, greenhouse gas capture equipment, greenhouse gas liquification equipment, and greenhouse gas fluid storage equipment for the onsite collection of the captured greenhouse gas from the greenhouse gas emission sources. The system can further include a transport collection system having one or more transporters that can remove the liquified greenhouse products from the onsite storage equipment and transport the greenhouse products to a location for environmentally acceptable sequestration or utilization, thus reducing the amount of greenhouse gas released to the atmosphere.

The disclosure provides a system for capture and sequestration of greenhouse gas, the system configured to interface with exhaust gas generation equipment in one or more industrial sites that generates exhaust gas having at least one greenhouse gas and remote sequestration or utilization sites, comprising: exhaust gas collection equipment configured to collect the exhaust gas from the gas generation equipment; greenhouse gas capture equipment configured to receive a flow of the exhaust gas from the exhaust gas collection equipment and separate the greenhouse gas to be captured from the exhaust gas; greenhouse gas liquification equipment configured to receive a flow of the greenhouse gas from the greenhouse gas capture equipment and reduce the greenhouse gas to a greenhouse gas fluid; greenhouse gas fluid storage equipment configured to receive a flow of the greenhouse gas fluid from the greenhouse gas liquification equipment and at least temporarily store the greenhouse gas fluid; and one or more transporters configured to remove the greenhouse gas fluid from the greenhouse gas fluid storage equipment at the one or more sites and transport the greenhouse gas fluid to remote sequestration or utilization sites. The sequestration sites can include commercial underground carbon dioxide storage, or wellsites with gas fluid injection equipment configured to receive a flow of the greenhouse gas fluid from the transporters and inject the greenhouse gas fluid into the geological formation for permanent sequestration. The utilization sites can include EOR (Enhanced Oil Recovery) facilities using liquid greenhouse gas, such as carbon dioxide, food and beverage industry, any other industry using carbon dioxide or other greenhouse gases as part of their processing.

The disclosure further provides a system for capture, sequestration or utilization of greenhouse gas from exhaust gas generation equipment, comprising: a greenhouse capture unit and a transport collection system. The greenhouse capture unit comprises greenhouse gas capture equipment configured to receive a flow of the exhaust gas and separate the greenhouse gas to be captured from the exhaust gas; greenhouse gas liquification equipment configured to receive a flow of the greenhouse gas from the greenhouse gas capture equipment and reduce the greenhouse gas to a greenhouse gas fluid; and greenhouse gas fluid storage equipment configured to receive a flow of the greenhouse gas fluid from the greenhouse gas liquification equipment and at least temporarily store the greenhouse gas fluid. The transport collection system comprises one or more transporters configured to collect the greenhouse gas fluid from the greenhouse gas fluid storage equipment and transport the greenhouse gas fluid to a sequestration-utilization system having at least one of a sequestration site and a utilization site.

### BRIEF DESCRIPTION OF THE SEVERAL VIEWS OF THE DRAWINGS

FIG. 1 is a schematic diagram of an example of a greenhouse gas, such as carbon dioxide, capture and collection system from multiple industrial sites, and transport for final sequestration or utilization according to the invention.

FIG. 2A is a schematic diagram showing an embodiment of an individual greenhouse gas capture unit coupled to a power generator unit as a greenhouse gas emission source.

FIG. 2B is a schematic diagram showing an embodiment of an individual greenhouse gas capture unit coupled to multiple power generators units as greenhouse gas emission sources.

FIG. 3 is a schematic diagram of a waste heat power generation system that optionally can be coupled to greenhouse gas capture unit to provide power to the equipment used during exhaust gas collection, greenhouse capture, storage, and liquification.

FIG. 4 is a schematic diagram showing an example of an embodiment of greenhouse gas capture equipment.

FIG. 5A is a schematic diagram showing an example of a transporter and a sequestration site that can include wellsites conducting fracturing operations.

FIG. 5B is a schematic diagram showing a transporter and another option of a commercial sequestration site that can include underground geological storage for the greenhouse gas fluid.

FIG. 5C is a schematic diagram showing a transporter and sites options for utilization of the greenhouse gas fluid.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer’s ultimate goal for the commercial embodiment. Such implementation-specific decisions may include, and likely are not limited to, compliance with system-related, business-related, government-related, and other constraints, which may vary by specific implementation or location, or with time. While a developer’s efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. Any expressions of percentage ranges and other ranges herein are inclusive, unless stated otherwise, and increments of the range can increase and decrease by integer numbers or fractions, so that for example a range of 0 to 10 includes 0 and 10 and any and all integers therebetween (e.g. 1, 2, 3 ...) and any and all fractions between each integer (e.g. 0.1, 0.2, 0.3, ... and 0.01, 0.02, 0.03, ..., and so forth). The term “sequestration:” as used herein is intended to mean a storage of gas in any phase in a subsurface formation, such as by adsorption or absorption; in a surface opening, such as a well, reservoir, or other cavity; in a designated long term storage facility; in storage containers for use in enhanced oil recovery facilities; in storage containers for industrial or commercial use in processes; or in other storage containers in which use reduce an amount of gas entering the Earth’s atmosphere.

The disclosure provides a system to capture greenhouse gas, such as carbon dioxide, from an exhaust of an onsite greenhouse gas emission source and liquefy the greenhouse gas exhaust for temporary storage onsite. The system can integrate the greenhouse gas emission source, such as industrial grade power generators, with exhaust gas collection equipment, greenhouse gas capture equipment, greenhouse gas liquification equipment, and greenhouse gas fluid storage equipment for the onsite collection of the captured greenhouse gas from the greenhouse gas emission sources. The system can further include a transport collection system having one or more transporters that can remove the liquified greenhouse products from the onsite storage equipment and transport the greenhouse products to a location for environmentally acceptable sequestration or utilization, thus reducing the amount of greenhouse gas released to the atmosphere.

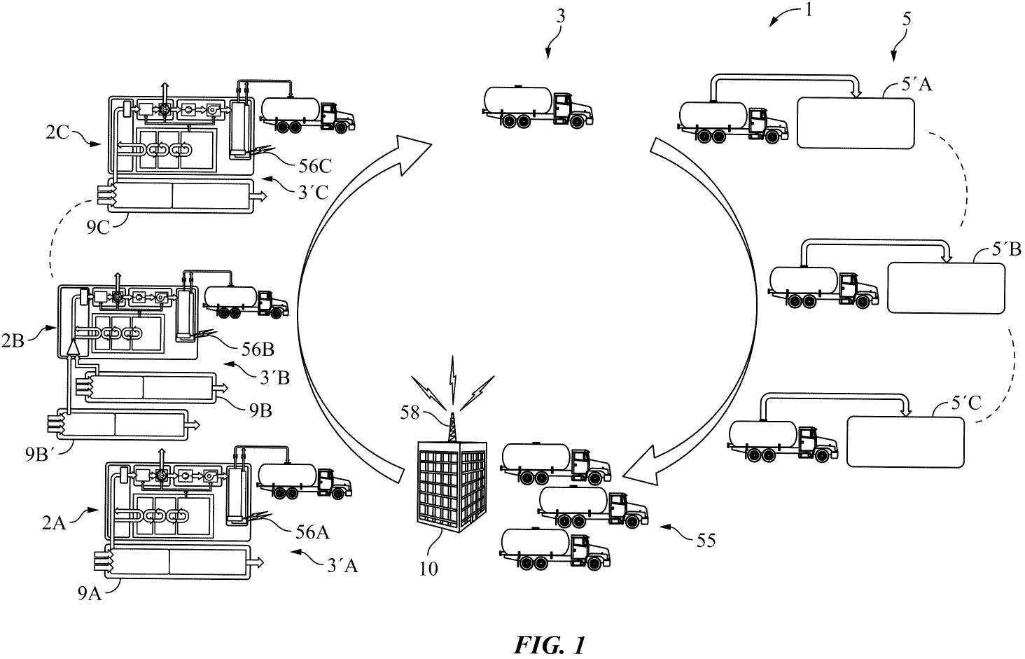

FIG. 1 is a schematic diagram of an example of a greenhouse gas, such as carbon dioxide, capture and collection system from multiple industrial sites, and transport for final sequestration or utilization according to the invention. In an overview of at least one embodiment, the system 1 includes one or more sites in multiple industries like agriculture, mining, data centers, petrochemicals, telecommunications, oil & gas, and so forth. such as sites 3′A, 3′B, and 3′C (collectively “3′”), with greenhouse gas capture units, such as units 2A, 2B, and 2C (collectively “2”), coupled to one or more greenhouse emissions sources 9A, 9B and 9B′, and 9C (collectively “9”), respectively. The greenhouse gas emission sources 9 can include industrial grade (high power output) power generators with internal combustion engines (“ICEs”), turbines that produce greenhouse gas, and other sources of greenhouse gas emissions. The greenhouse gas capture units 2 can be modular and include exhaust gas collection equipment, greenhouse gas capture equipment, greenhouse gas liquification equipment, and greenhouse gas fluid storage equipment, described in more detail below. The system 1 further includes a transport collection system 3 for transporting liquified greenhouse products from the greenhouse gas collection sites 3′. The system 1 further can include a sequestration-utilization system 5 having one or more sequestration and/or utilization sites, such as sites 5′A, 5′B, and 5′C (collectively “5”′) to which the transport collection system 3 can transport the liquified greenhouse products for sequestration or utilization.

With a greenhouse gas capture unit 2, the greenhouse exhaust gas that would typically be exhausted to the atmosphere from greenhouse gas emission sources is rather captured, liquified, and stored in unit storage containers in the greenhouse gas capture unit. The greenhouse gas products in storage can be in the form of a gas fluid for compact storage. When one or more sensors coupled to the unit storage containers on greenhouse gas capture generator units 2 sense a level of gas fluid that needs emptying from one or more particular unit storage containers, one or more transmitters 56A, 56B, and/or 56C (collectively “56”) coupled to the sensors on the greenhouse gas capture generator units can signal a receiver 58 on a transport collection control center 10. Data from the signal of the transmitter 56 can be used to schedule a transporter 55 to perform a trip to collect the gas fluid from the one or more greenhouse gas capture units 2. The transporter 55 can transport the gas fluid to one or more sites of the sequestration-utilization system 5. The sequestration-utilization system 5 can include multiple embodiments, including greenhouse gas sequestration wellsites 5′A, other sequestration sites 5′B, and greenhouse gas utilization sites 5′C.

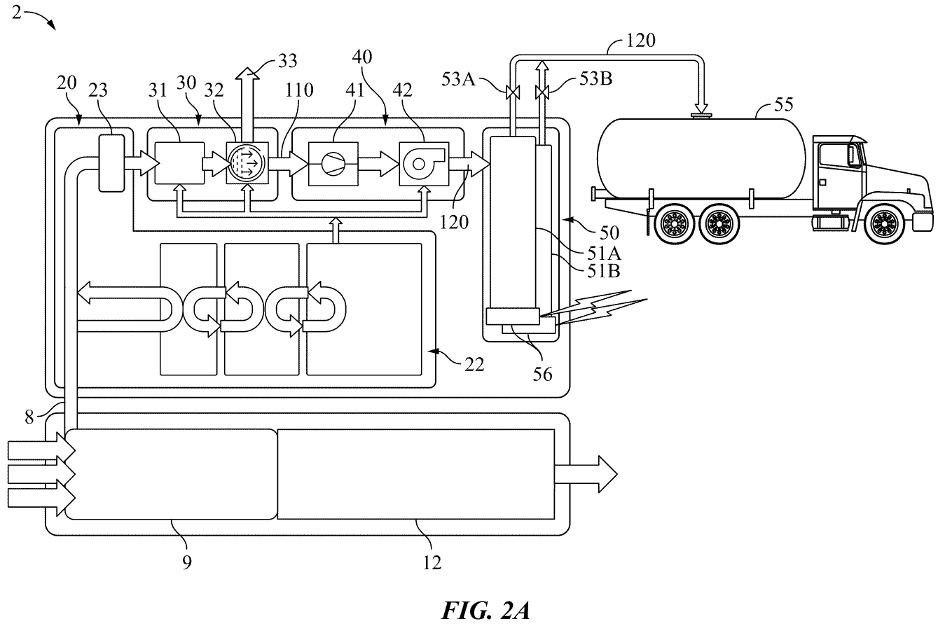

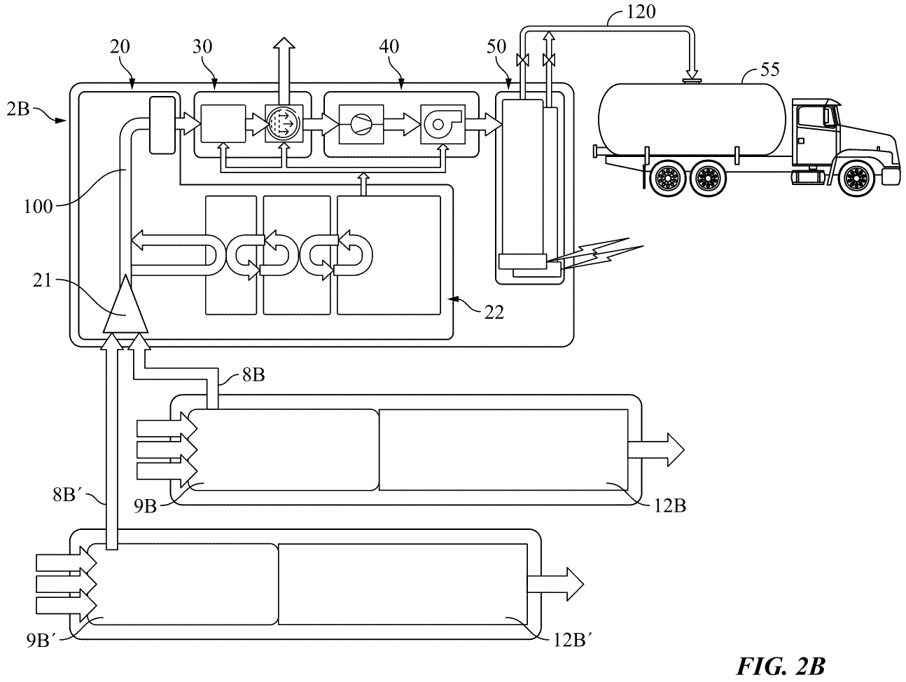

FIG. 2A is a schematic diagram showing an embodiment of an individual greenhouse gas capture unit coupled to a power generator unit as a greenhouse gas emission source. Greenhouse gas emission source 9 can be one or more internal combustion engines (“ICE”), turbines, or other gas emission sources as a motive source for a power generator unit 12. The greenhouse gas capture unit 2 can receive through at least a conduit the exhaust gas 8 from an exhaust device of a greenhouse gas emission source 9. Optionally, the exhaust gas can pass through ancillary equipment, including without limitation prefilters for particulates, liquids, and other contaminates for a cleaner gas effluent from exhaust gas collection equipment; pressure compensators; controls; and other appropriate features with the collection of gases, while avoiding performance-affecting back pressure into gas emission source 9. The exhaust gas 8 from the gas emission source can at least partially flow through a waste heat power generation system 22, described below, and then return to the main flow of the exhaust gas 8. The exhaust gas can flow through an exhaust gas blower 23 to help flow the exhaust gas through at least portions of the greenhouse gas capture unit 2. The exhaust gas can proceed to greenhouse gas capture equipment 30, greenhouse gas liquification equipment 40, and greenhouse gas fluid storage equipment 50, where each can be sized on an individual unit basis.

Greenhouse gas capture equipment 30 can capture and separate greenhouse gas, such as carbon dioxide, from other gases in the exhaust gas stream. An example of greenhouse gas capture equipment is shown. The greenhouse gas capture equipment 30 can include an exhaust gas cooler 31 to cool the exhaust gas. The cooled exhaust gas can flow into a filter 32 for filtering one or more greenhouse gases in the exhaust gas and releasing undesired gases 33, such as nitrogen and oxygen, into the atmosphere, thereby creating an at least partially purified greenhouse gas 110 for sequestration. Alternatively, other greenhouse gas capture equipment (not shown) can be coupled to the illustrated embodiment of the greenhouse gas capture equipment or the upstream exhaust gas collection equipment to capture other gases, instead of releasing such gases to the atmosphere. The goal of the greenhouse gas capture equipment is a purified greenhouse gas 110 of a desired composition for a next step in the system process. Without limitation, an example of a desirably purified greenhouse gas 110 would be at least 90% pure, more desirable is at least 95% pure, further desirable is at least 99% pure, and still further desirable is at least 99.9% pure, and any value between such values, although other values may be acceptable for given commercial and technical reasons. A vacuum pump (not shown) can be coupled downstream of the filter 32 to provide additional energy for the gas to pass through the filter. Other devices can be used instead of the vacuum pump, depending of the releasing and regeneration methods suitable for the greenhouse filter.

Greenhouse gas liquification equipment 40 that compresses the purified greenhouse gas 110 to a smaller volume can be coupled to, and is generally downstream of, the greenhouse gas capture equipment 30. In at least one embodiment, the greenhouse gas liquification equipment 40 can include a relatively low-pressure gas compressor 41 to compress the purified greenhouse gas 110 and form a compressed gas fluid 120 for an initial volume reduction and energy increase, followed by a higher pressure pump 42 to increase pressure of the gas fluid. The compression may be sufficient to compress to a liquid fluid (herein, collectively referred to as a “gas fluid” unless stated otherwise). Other methods of creating a denser fluid from the greenhouse gas are also available, such a temperature-induced densification.

Greenhouse gas fluid storage equipment 50 can be coupled to, and is generally downstream of, the greenhouse gas liquification equipment 40. The gas fluid can be pumped to at least one and advantageously at least two gas fluid unit storage containers 51A and 51B, such as cylinders. Outlet valves 53A and 53B for the storage cylinders can release the stored gas fluid as needed for collection by the transport collection system 3. For example, such transportation of the gas fluid 120 can occur with containers, transport vehicles, rail cars and trains, pipelines, and other transportation equipment (herein referred to as a “transporter” 55) and related methods. Releasing the gas fluid into a transporter can occur with a periodic collection protocol or on a signal initiated collection, such as a just-in-time protocol. The just-in-time protocol can be based on a sensor coupled to a unit storage container that can sense a filling condition of the gas fluid, such as volume, weight, pressure, temperature, or other condition that may assist in signaling the transporter collection system 3.

FIG. 2B is a schematic diagram showing an embodiment of an individual greenhouse gas capture unit coupled to multiple power generators units as greenhouse gas emission sources. Greenhouse gas emission sources 9B and 9B′ provide motive sources for power generator units 12B and 12B′. The greenhouse gas capture unit 2B can collect through at least a conduit the exhaust gases 8B and 8B′ from the gas emission sources 9B and 9B′ and combine the exhaust gases in an exhaust gas collector 21 of greenhouse gas collection equipment 20 into a combined exhaust gas 100. Optionally, the exhaust gas can pass through ancillary equipment, including without limitation prefilters for particulates, liquids, and other contaminates for a cleaner gas effluent from the exhaust gas collection equipment; pressure compensators; controls; and other appropriate features with the collection of gases, while avoiding performance-affecting back pressure into gas emission sources 9B and 9B′. The combined exhaust gas 100 can at least partially flow through a waste heat power generation system 22, described below, and then return to the main flow of the combined exhaust gas 100. The combined exhaust gas can proceed to greenhouse gas capture equipment, greenhouse gas liquification equipment, and greenhouse gas fluid storage equipment, as described in FIG. 2A, where each can be sized for the combined exhaust gas volume.

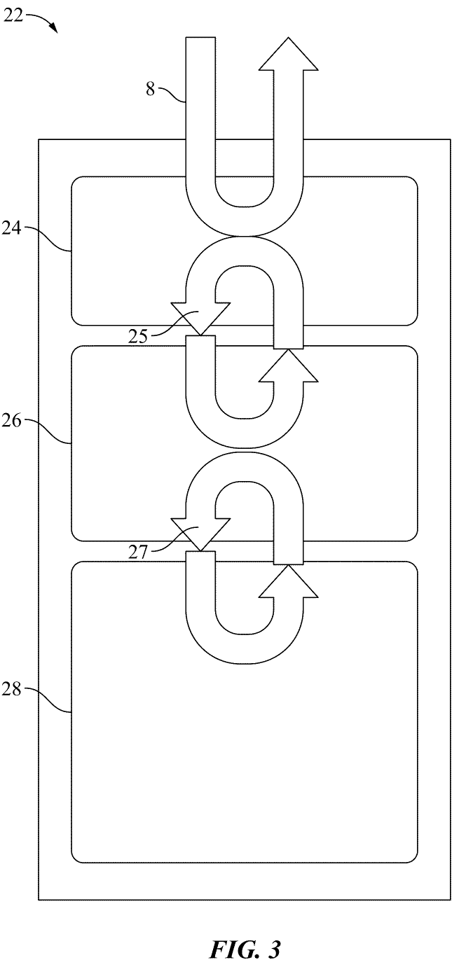

FIG. 3 is a schematic diagram of a waste heat power generation system that optionally can be coupled to systems described herein to provide power to the equipment used during exhaust gas collection, greenhouse capture, storage, and liquification. The waste heat power generation system 22 can at least partially power any of the equipment in the greenhouse gas capture unit 2 (or other equipment) including the exhaust gas blower, greenhouse gas capture equipment, and greenhouse liquification equipment in the embodiments described herein. In at least one embodiment, an Organic Rankine Cycle can be implemented. The system 22 can be incorporated into the overall systems at a point in which the exhaust gas 8 has high energy, generally close to the exhaust gas collection equipment 20. As an example of one type of greenhouse gas emission source, the temperature of exhaust gas at the ICE, is typically from 350 to 700° C. Further, the heat of an ICE cooling system can also be recovered at around 95° C. Waste heat from the ICE exhaust gas and cooling system can be used to generate mechanical power. The system 22 can receive hot exhaust gas 8 from an outlet of a main exhaust gas flow, pass through a first heat exchanger 24 to transfer some of the exhaust gas heat energy, and then return to the main flow of the combined exhaust gas 8 at a lower temperature. In the first heat exchanger 24, an intermediate fluid known as a thermal oil, can flow in a closed intermediate heat transfer loop 25 that is coupled to both the first heat exchanger 24 and the second heat exchanger 26. The intermediate fluid circulates in its intermediate heat transfer loop 25 back to the first heat exchanger 24 to be reheated by more exhaust gas 8 passing through the first heat exchanger. The intermediate fluid is fluidicly separate from the hot exhaust gas 8 flow, but is heated by the exhaust gas in the first heat exchanger. The intermediate fluid can then heat a working fluid in a similar manner. The working fluid flows in a closed working fluid loop 27 that is coupled to both the second heat exchanger 26 and a power generation unit 28. The working fluid is fluidicly separate from the intermediate fluid, but is heated by the intermediate fluid in the second heat exchanger 26. The intermittent nature of the well construction processes of drilling and/or fracturing creates an intermittent flow of exhaust gases and therefore a fluctuation in the waste heat. To provide a more stable flow of energy in the waste heat power generation system 22, the intermediate fluid in the loop 25 acts as a heat energy buffer between the exhaust gas 8 and the working fluid in the loop 27 to moderate fluctuations in the flow of the exhaust gas and the transferable heat. The working fluid can flow through the loop 27 and power generation unit 28 to generate power such as by mechanically turning a power turbine or other power generation equipment 28. The power generation equipment 28 can generate electricity for the equipment in the overall system, such as in the exhaust gas blower 23, greenhouse gas capture equipment 30, greenhouse gas liquification equipment 40, and greenhouse gas fluid storage equipment 50, with little to no additional energy from an external source for such equipment.

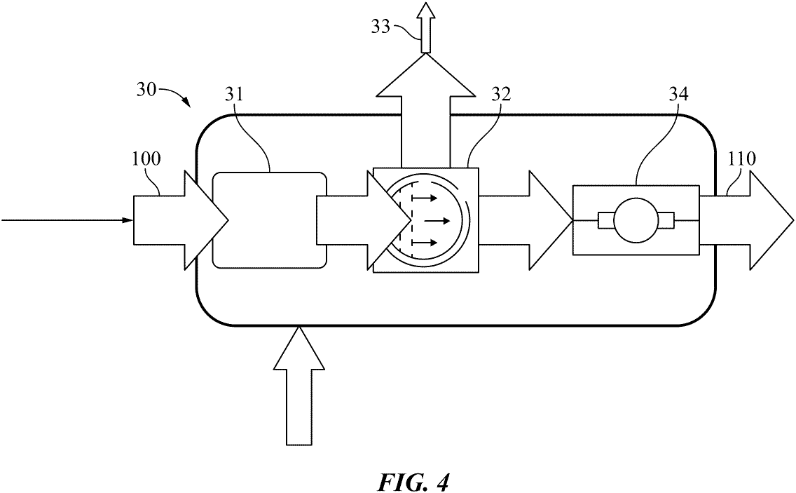

FIG. 4 is a schematic diagram showing an example of an embodiment of greenhouse gas capture equipment. The greenhouse gas capture equipment 30 can receive gas, such as exhaust gas 8 having a mixtures of gases, and clean the mixture to produce an at least partially purified greenhouse gas 110, and release the undesirable gas 33 into the atmosphere. The greenhouse gas capture equipment 30 can include a gas cooler 31 to cool the incoming exhaust gas 8. The greenhouse gas capture equipment can also include an greenhouse gas filter 32 coupled downstream of the exhaust gas cooler for filtering out one or more of the components in the exhaust gas and can release undesirable gas 33 into the atmosphere (which may not be greenhouse gases), while retaining an at least partially purified greenhouse gas 110. A vacuum pump 34 can be coupled downstream of the filter 32 to provide differential pressure to provide additional energy to the gas to pass through stages of the system. Other devices can be used instead of the vacuum pump, depending of the releasing and regeneration methods required by the greenhouse filter. In an exemplary embodiment, the greenhouse gas capture equipment 30 can use a greenhouse filter. The term “filter” is used broadly to include any method of separating the gases. In one embodiment, it can use a physical and/or chemical absorption method. In this method, the greenhouse gas filter can use specialized liquid chemicals, such as amine solvents with any regeneration process for capturing and releasing the desired gas(es). In another embodiment, the greenhouse gas filter equipment can include physical and/or chemical adsorption method. In this method, the greenhouse gas filter can use specialized materials such as, metallic organic frameworks (MOFs), melamine porous networks, graphene, zeolites, each of which use specific principles for capture the CO2 and requires specific methods for releasing the CO2 and regenerating the filter for further CO2 captures. In another embodiment, the greenhouse gas filter equipment can include physical separation like in membranes of different types. In another embodiment, the greenhouse gas capture equipment can biological filtering methods.

Still further, in other embodiments, the greenhouse gas capture equipment can include temperature, including cryogenic, equipment and related processes for capturing the desired gas(es). Other devices can be part of the greenhouse gas capture equipment, depending of the releasing and regeneration methods required by the greenhouse gas filter equipment. Other embodiments are also possible, including combinations of the above embodiments. Alternatively, the gas capture equipment can flow the purified greenhouse gas 110 to other greenhouse filter equipment for processing out of one or more other undesirable gases 33 for further purification of the purified greenhouse gas 110. The system can be modular and scalable to accommodate different greenhouse emission sources sizes with different gas emission volumes and gas purity specifications. The type, size, and quantify of filters can depend on the desired purity level. For example, industrial and medical uses expect 99.5% purity, bone dry uses expect 99.8% purity, food and beverage uses expect 99.9% purity, anaerobic and laser uses expect 99.95% purity, and research uses expect 99.999% purity. Also, any public transportation of the system, such as being mounted on skids or trailers, should comply with applicable governmental standards.

As described above, the transport collection system 3 can service the unit storage containers to receive the stored gas fluid and deliver the gas fluid to sequestration and/or utilization locations.

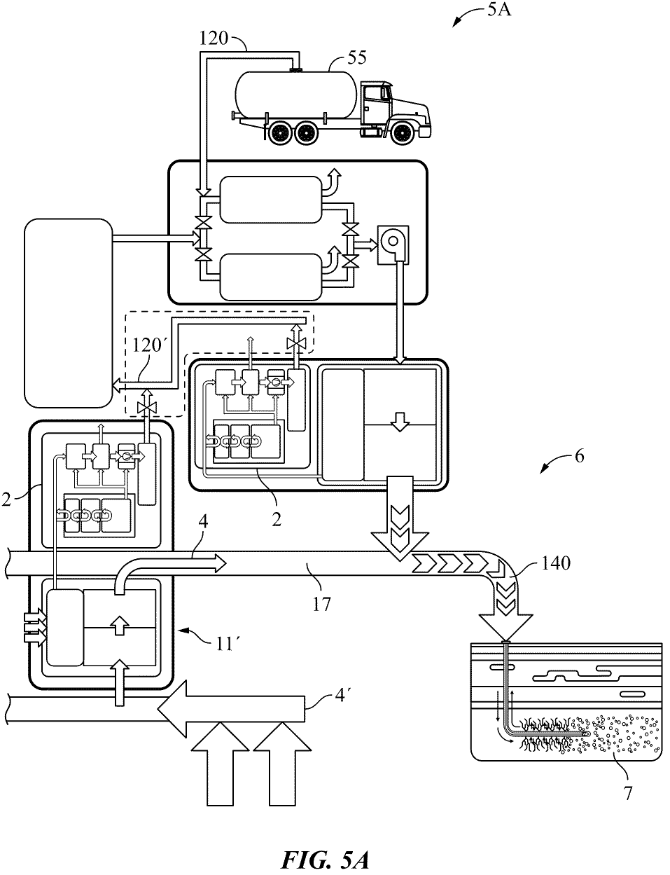

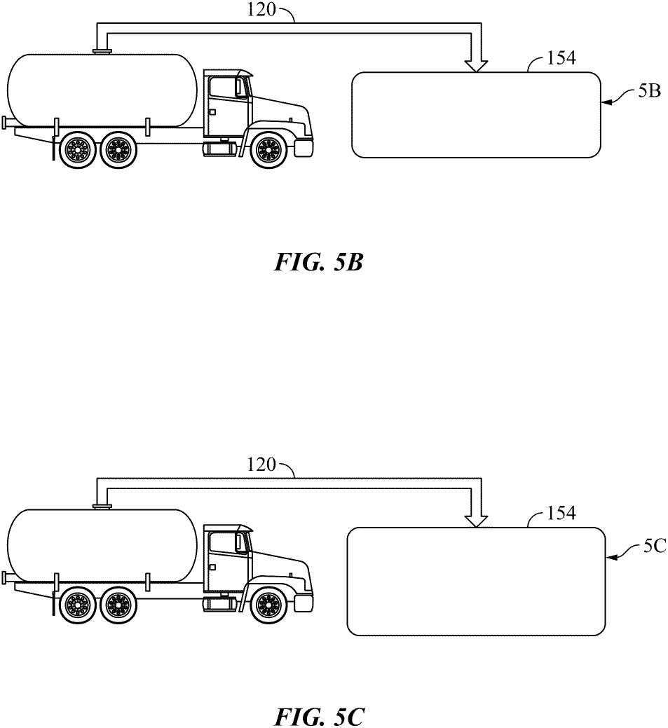

FIG. 5A is a schematic diagram showing an example of a transporter and a sequestration site that can include wellsites conducting fracturing operations. In general, this embodiment is an example of a sequestration site 5A can receive greenhouse gas fluid from the transporter 55. The sequestration system 5A can include a greenhouse gas capture unit 2 for a wellsite greenhouse gas emission source, such as an ICE, coupled to a high pressure fracking pump. The fracking pump receives low pressure fracking fluid 4′ on a low pressure side of the pump and increases the pressure of the fracking fluid on a high pressure side. The high pressure fluid 4 can flow into an output manifold 17 and is injected at a high pressure into the well at the wellsite 6 and into the formation 7 for creating voids in the formation to allow hydrocarbons to flow out and into a production pipe to the surface.

The transporter 55 can deliver the collected greenhouse gas fluid 120 in liquid form to the sequestration site 5A to be pumped into the high-pressure fracturing fluid 4 from fracking units to become a combined mixture as a gas fracking fluid 140 and pumped downhole in the wellsite to be sequestered by one or more subsurface formations 7. The greenhouse gas fluid 120 can be combined with greenhouse gas fluid 120′ produced by the greenhouse gas capture unit 2 for the greenhouse gas emission source for the fracking pump. Further details are described in the U.S. Application Serial No. 18/158,118, which is incorporated by reference herein.

FIG. 5B is a schematic diagram showing a transporter and another option of a sequestration site that can include underground geological storage for the greenhouse gas fluid. The transporter 55 can deliver the greenhouse gas fluid 120 to a sequestration site 5B, which can include a commercial underground greenhouse gas storage 154, such as for carbon dioxide.

FIG. 5C is a schematic diagram showing a transporter and an option for utilization of the greenhouse gas fluid. Various facilities and industries can be used for utilization of the greenhouse gas fluid 120 from the transporter 55. The transporter can deliver the gas fluid 120 into facilities such as Enhanced Oil Recovery (EOR) facilities, food and beverage and other industries using greenhouse gas, such as in their processing.

Thus, the capture, collection, and sequestration system described herein can yield a near zero-carbon footprint in a commercially viable manner acceptable to the government and the public.

Other and further embodiments utilizing one or more aspects of the inventions described above can be devised without departing from the disclosed invention as defined in the claims. For example, other embodiments can include various other gases, other types of greenhouse gas capture equipment, other types of transporters, and other variations than those specifically disclosed herein within the scope of the claims. Further, the various embodiments can be combined or split in various ways, such as different portions of the overall system equipment being located at different locations.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicant intends to protect fully all such modifications and improvements that come within the scope of the following claims.

What is claimed is:

1. A system for capture, sequestration or utilization of greenhouse gas, the system configured to interface with exhaust gas generation equipment in one or more industrial sites that generates exhaust gas having at least one greenhouse gas and remote sequestration or utilization sites, comprising:
greenhouse gas capture equipment configured to receive a flow of the exhaust gas and separate the greenhouse gas to be captured from the exhaust gas;
greenhouse gas liquification equipment configured to receive a flow of the greenhouse gas from the greenhouse gas capture equipment and reduce the greenhouse gas to a greenhouse gas fluid;
greenhouse gas fluid storage equipment configured to receive a flow of the greenhouse gas fluid from the greenhouse gas liquification equipment and at least temporarily store the greenhouse gas fluid; and
one or more transporters configured to remove the greenhouse gas fluid from the greenhouse gas fluid storage equipment at the one or more sites and transport the greenhouse gas fluid to at least one of a remote sequestration site or a utilization site.

2. The system of claim 1, further comprising exhaust gas collection equipment configured to collect the exhaust gas from the exhaust gas generation equipment and provide the exhaust gas to the greenhouse gas capture equipment.

3. The system of claims 2, wherein the exhaust gas collection equipment is configured to collect exhaust gas from multiple units of the exhaust gas generation equipment.

4. The system of claim 1, wherein the sequestration site comprises a commercial underground carbon dioxide storage.

5. The system of claim 1, wherein the sequestration site comprises a wellsite with gas fluid injection equipment configured to receive a flow of the greenhouse gas fluid from the one or more transporters and inject the greenhouse gas fluid into a geological formation for sequestration.

6. The system of claim 1, wherein the utilization site comprises any industry using a greenhouse gas as part of processing at least one of an Enhanced Oil Recovery (EOR) facility, food and beverage industry, an anaerobic facility, a laser facility for manufacturing, testing or research, and a research facility any other industry using carbon dioxide or other greenhouse gases as part of their processing.

7. A system for capture and sequestration or utilization of greenhouse gas from exhaust gas generation equipment, comprising:
a greenhouse capture unit comprising:
greenhouse gas capture equipment configured to receive a flow of the exhaust gas and separate the greenhouse gas to be captured from the exhaust gas;
greenhouse gas liquification equipment configured to receive a flow of the greenhouse gas from the greenhouse gas capture equipment and reduce the greenhouse gas to a greenhouse gas fluid;
greenhouse gas fluid storage equipment configured to receive a flow of the greenhouse gas fluid from the greenhouse gas liquification equipment and at least temporarily store the greenhouse gas fluid; and
a transport collection system, comprising:
one or more transporters configured to collect the greenhouse gas fluid from the greenhouse gas fluid storage equipment and transport the greenhouse gas fluid to a sequestration-utilization system having at least one of a sequestration site and a utilization site.

8. The system of claim 7, wherein
the greenhouse gas fluid storage equipment comprises:
a sensor configured to indicate a filling condition of the greenhouse gas fluid storage; and
a transmitter configured to receive the filling condition from the sensor and transmit a signal of the condition to the transport system comprising an instruction to collect at least a portion of the greenhouse gas fluid from the greenhouse gas fluid storage equipment, and
the transport collection system comprises a receiver configured to receive the signal of the filling condition from the transmitter and direct a transporter to collect the at least portion.

9. The system of claim 7, wherein the sequestration site comprises a commercial underground carbon dioxide storage.

10. The system of claim 7, wherein the sequestration site comprises a wellsite with gas fluid injection equipment configured to receive a flow of the greenhouse gas fluid from the one or more transporters and inject the greenhouse gas fluid into a geological formation for sequestration.

11. The system of claim 7, wherein the utilization site comprises any industry using a greenhouse gases as part of processing at least one of an Enhanced Oil Recovery (EOR) facility, food and beverage industry, an anaerobic facility, a laser facility for manufacturing, testing or research, and a research facility any other industry using carbon dioxide or other greenhouse gases as part of their processing.
